(19) United States
(12) Patent Application Publication
(10) Pub. No.: US 2014/0188394 A1
(43) Pub. Date: Jul. 3, 2014

(54) DETERMINING SEISMIC RESPONSE CHARACTERISTICS OF STRUCTURES

(71) Applicant: INTERNATIONAL BUSINESS MACHINES CORPORATION, Armonk, NY (US)

(72) Inventors: Barbara Febonio, Rome (IT); Sandro Piccinini, Rome (IT); Stefano Sidoti, Rome (IT)

(73) Assignee: INTERNATIONAL BUSINESS MACHINES CORPORATION, Armonk, NY (US)

(21) Appl. No.: 13/728,614

(22) Filed: Dec. 27, 2012

(51) Int. Cl. G06F 17/40

(52) U.S. Cl. CPC G06F 17/40
USPC 702/15

(57) ABSTRACT

A system, method and/or software for determining at least one characteristic of at least one structure. A server sub-system includes a processor set and seismic software that runs on the processor set. The sever sub-system being in data communication with a communication network. The server sub-system receives, through the communication network, first detected movement information, relating to seismically-induced physical movement of a first client device. The server sub-system performs structure-characteristic determination, by its seismic software, to determine at least one structure characteristic of a first structure based, at least in part, upon the first detected movement information. Preferably, detected movement data from a great many client devices is utilized in performing the structure-characteristic determination.

### FIELD OF THE INVENTION

The present invention relates generally to the field of seismic analysis, and more particularly to seismic analysis using computer network.

### BACKGROUND OF THE INVENTION

It is currently known to use computer networks to analyze seismic events. For example, the following website http://phys.org/news/2010-10-ibm-inventors-accurately-natural-disasters.html states as follows: “[A] technique can enable a system that accurately and precisely conducts post-event analysis of seismic events, such as earthquakes, as well as provide early warnings for tsunamis, which can follow earthquakes. The invention also provides the ability to rapidly measure and analyze the damage zone of an earthquake to help prioritize emergency response needed following an earthquake. The invention uses data generated by vibration sensors (known as MEMS accelerometers) within computer hard disk drives to quickly analyze and assess information generated by seismic events. This technique is enabled by collecting hard drive sensor data and transmitting it via high speed networking to a data processing center, which can analyze the data, classify the events, and enrich the data—in real time.”

It is currently known to determine seismic response characteristics of buildings and/or other structures (generally geological structures) to determine the response of the structure to a seismic event, such as an earthquake. These conventional techniques are sometimes called “seismic analysis” (see, for example, the following website: http://en.wikipedia.org/wiki/Seismic_analysis). Herein, in order to avoid confusion with other types of earthquake-related analysis: (i) the determination of seismic response characteristics of buildings and/or other structures will be referred to as “seismic structure-characteristic determination” (or, more simply, as “structure-characteristic determination,” or, even more simply as “SCD”); (ii) the determination of seismic response characteristics of buildings, specifically, will be referred to as “seismic building-characteristic determination” (or “SBCD”); and (iii) determination of seismic response characteristics of geologic structures, specifically, will be referred to as “seismic geo-characteristic determination” (or “SGCD”)

### SUMMARY

According to an aspect of the present invention, a method determines at least one characteristic of at least one structure. This the method includes the following steps (not necessarily in the following order. (i) providing a server sub-system comprising a processor set and seismic software that runs on the processor set, with the sever sub-system being in data communication with a communication network; (ii) receiving, by the server sub-system and through the communication network, first detected movement information, relating to seismically-induced movement of a first client device; and (iii) performing “structure-characteristic determination” (or, SCD), by the seismic software of the server sub-system, to determine at least one structure characteristic of a first structure based, at least in part, upon the first detected movement information.

### BRIEF DESCRIPTION OF THE SEVERAL VIEWS OF THE DRAWINGS

FIG. 1 is a schematic view of a first embodiment of a seismic computer system according to the present invention;

FIG. 2A is a schematic view of a server computer sub-system portion of the first embodiment computer system;

FIG. 2B is a schematic view of a client computer sub-system portion of the first embodiment computer system;

FIG. 3A is a schematic view of a portion of the server sub-system of the first embodiment computer system;

FIG. 3B is a schematic view of a portion of a client sub-system of the first embodiment computer system;

FIG. 4 is a flowchart showing a process according to the present invention;

FIG. 5 is a perspective view of a geological and architectural environment in which a portion of the first embodiment computer system is deployed; and

FIG. 6 is a first screenshot generated by the first embodiment computer system.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

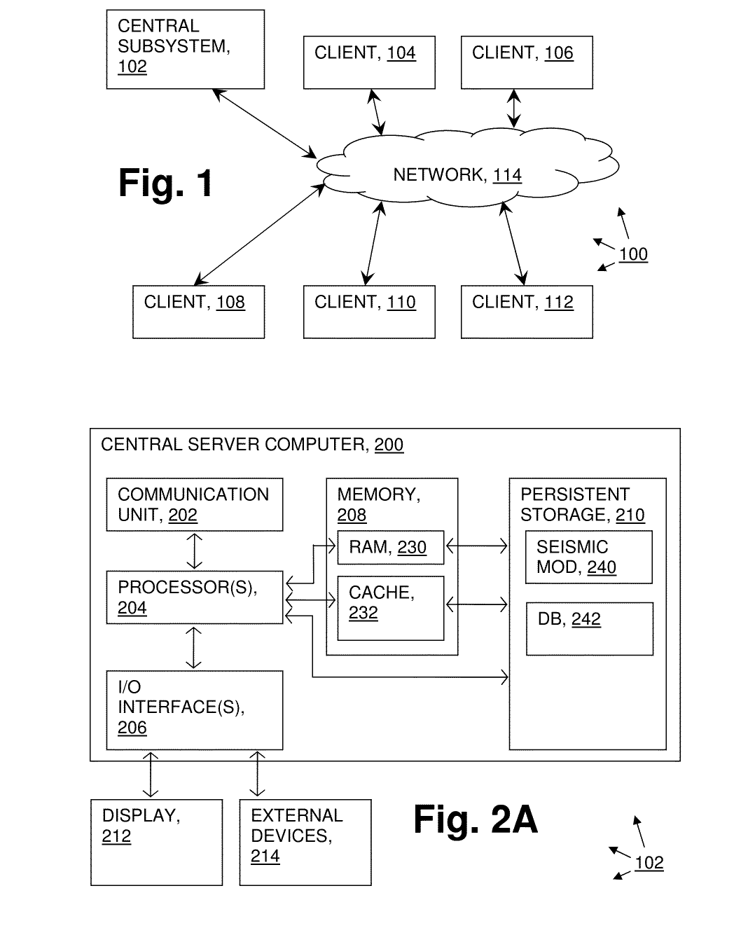

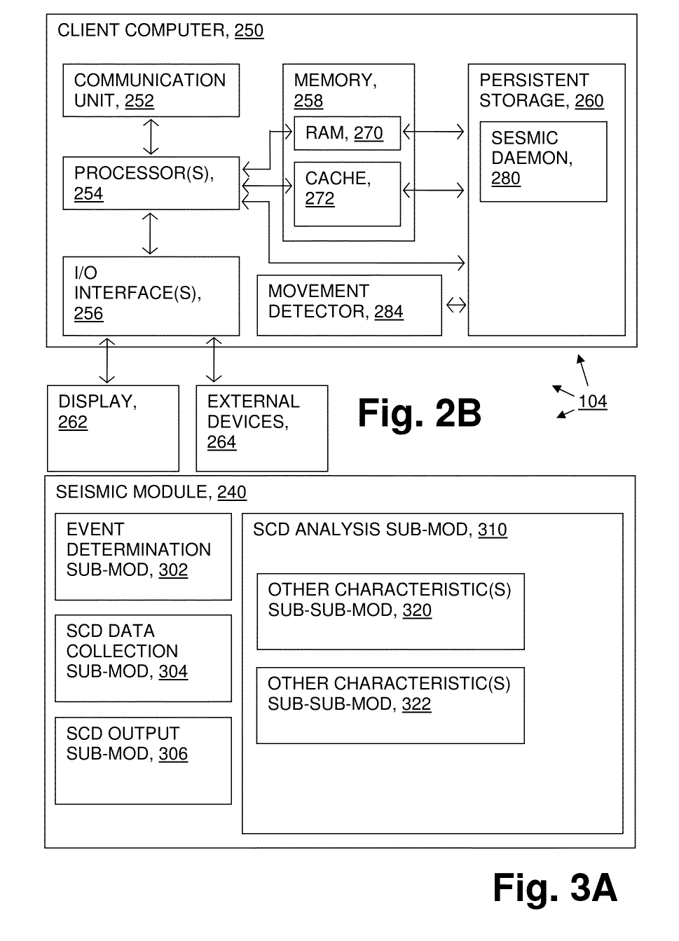

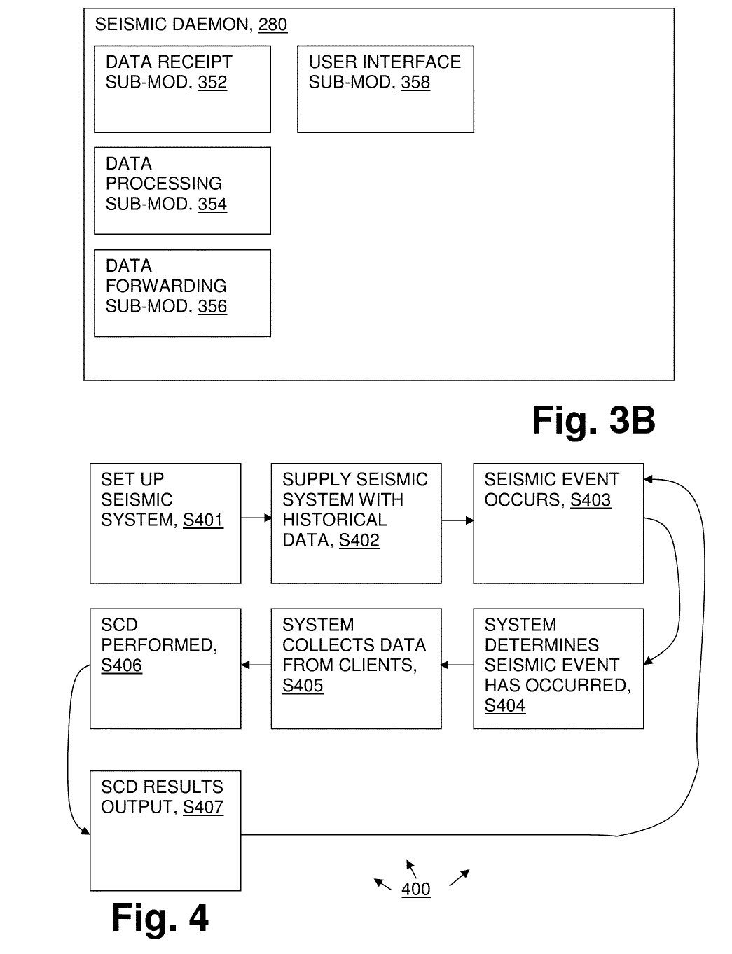

The present invention will now be described in detail with reference to the Figures. FIGS. 1, 2A, 2B, 3A, and 3B are each a functional block diagram illustrating various portions of seismic-characteristic determination system 100, including: central sub-system 102; client sub-systems 104, 106, 108, 110, 112; and communication network 114. As shown in FIG. 2A: central sub-system 102 includes: central server computer 200; communication unit 202; processor(s) 204; I/O interfaces 206; memory 208; random access memory (RAM) 230; cache 232; persistent storage 210; seismic module (or mod) 240; database 242; display 212; and external devices 214. As shown in FIG. 2B, representative client sub-system 104 includes: computer 250; communication unit 252; processor(s) 254; I/O interfaces 256; memory 258; random access memory 270; cache 272; persistent storage 260; seismic daemon 280; display 262; external devices 264; and movement detector 284. As shown in FIG. 3A, seismic mod 240 of central server computer includes: event determination sub-mod 302; SCD data collection sub-mod 304; SCD output sub-mod 306; SCD analysis sub-mod 310; elastic response characteristic sub-sub-mod 320; and other characteristic(s) sub-sub-mod 322. As shown in FIG. 3B, seismic daemon 280 of representative client computer 250 includes: data receipt sub-mod 352; data processing sub-mod 354; data forwarding sub-mod 356; and UI sub-mod 358.

Server computer 200 (see FIG. 2A) may be a laptop computer, tablet computer, netbook computer, personal computer (PC), a desktop computer, a personal digital assistant (PDA), a smart phone, or any programmable electronic device capable of communicating with the client sub-systems via network 114. As shown in FIG. 2A, seismic module 240 is a collection of machine readable instructions and database (db) 242 whose functions will be discussed in detail below.

Client computer 250 (see FIG. 2B) may be a laptop computer, tablet computer, netbook computer, personal computer (PC), a desktop computer, a personal digital assistant (PDA), a smart phone, or any programmable electronic device capable of communicating with the server and other client sub-systems via network 114. The software of seismic daemon 280 will be discussed in detail below.

Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

It should be appreciated that FIGS. 1, 2A, 2B, 3A, and 3B, taken together, provide only an illustration of one implementation (that is, system 100) and does not imply any limitations with regard to the environments in which different embodiments may be implemented. Many modifications to the depicted environment may be made, especially with respect to current and anticipated future advances in cloud computing, distributed computing, smaller computing devices, network communications and the like.

The following several paragraphs will discuss several features of server sub-system 102 (shown in FIG. 2A), but it should be kept in mind that this discussion is generally equally applicable to the various client sub-systems, such as sub-system 104 shown in FIG. 2B.

Turning again to FIG. 2A, server computer sub-system 102 is shown as a block diagram with many double arrows. These double arrows (no separate reference numerals) represent a communications fabric, which provides communications between various components of sub-system 102 as shown in FIG. 2A. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory sub-system 102.

The instructions and/or data stored in persistent storage 210 can be accessed and/or executed by one or more of the respective computer processors 204, usually through one or more memories of memory 208. Persistent storage 210 is at least more persistent than a signal in transit is, but the persistent storage may, of course, be substantially less persistent than permanent storage. Mods 240 and/or 242 may include both machine readable and performable instructions and/or substantive data. In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communication unit 202, in these examples, provides for communications with other data processing systems or devices external to sub-system 102, such as client sub-systems 104, 106, 108, 110, 112. In these examples, communication unit 202 includes one or more network interface cards. Communication unit 202 may provide communications through the use of either or both physical and wireless communications links. Any software modules discussed herein may be downloaded to a persistent storage device (such as persistent storage device 210) through a communications unit (such as communication unit 202).

Input/output (I/O) interface(s) 206 allows for input and output of data with other devices that may be connected locally in data communication with server computer 250. For example, I/O interface 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, seismic module 240, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Turning briefly to FIGS. 3A and 3B, discussion of the various modules, sub-modules and/or sub-sub-modules of FIGS. 3A and 3B will be discussed below of the flow chart of FIG. 4.

Turning now to FIG. 4, FIG. 4 is a flowchart depicting process 400 in accordance with an embodiment of the present invention. The various steps of process 400 will now be discussed in turn.

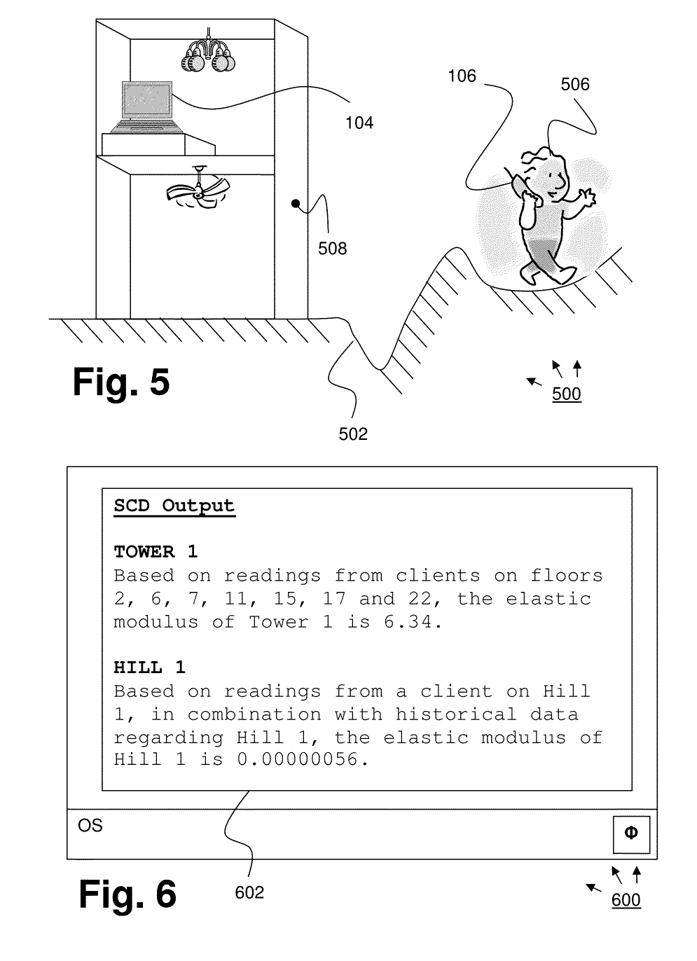

At step S401, the seismic computer system is set up and deployed. This means that the computer, network and software components identified above in FIGS. 1 to 3 are provided. While FIG. 1 shows a simplified system that has only five client sub-systems 104, 106, 108, 110, 112, it should be understood that some preferred embodiments will include many, many more client sub-systems. As shown in FIG. 5, deployment environment 500 includes: client sub-system 104; client sub-system 106; building structure 508; geological structures 502; and human user 506. As will be discussed in more detail below, the client sub-systems detect movement “out in the field,” this means that the various client sub-systems need to actually be deployed out in the field. If it is desired to perform SCD on a building, like building 508, then one or more client sub-systems should be deployed in that building. Similarly, if it is desired to perform SCD for a geological formation, like geological structures 502, then one or more client sub-systems will need to be deployed in and/or on the geological structure of interest.

It is noted that the central sub-system 102 (see FIG. 1) may also be distributed over multiple locations. Generally speaking, the geographical location of the central sub-system is not critical, although it is preferably placed where it is not likely to b destroyed by an earthquake, and can communicate over a communication network that is not likely to be shut down by an earthquake.

It should be understood that for many embodiments, step S401 will be an ongoing step that will continue to occur during all the rest of the steps shown in process 400 of FIG. 4. This is primarily because, at least in many embodiments, the users of the various client sub-systems will not consider the client sub-systems primarily as SCD data collection units, but rather as something else, such as: (i) a special purpose computer (for example, a data server in the form of a desktop computer); (ii) a general purpose computer (for example, an employee's business computer in the form of a laptop); or some other type of electronic device (for example, a smart phone). In these cases, the client device will join the system when seismic daemon 280 (see FIG. 2B) is loaded onto it and run. However, the user of the client device may not know it is even there, running in the background, or, if the user does know that the seismic daemon is there, then the user may not think very often about the SCD function of his device.

Referring briefly to FIG. 3B, UI sub-mod 358 is the sub-mod that allows the user or administrator of a client device to initially set up and/or modify the seismic daemon on the client device. There may be settings to be set locally at the client device, such as device sensitivity, frequency of checking movement data locally, frequency of forwarding movement data to the central sub-system, frequency of checking for new instructions from the central sub-system and so on. It will also be noted here that seismic daemon could be any other type of program, other than being specifically in the form of a daemon. However, at least in most embodiments of the present invention, the majority of client sub-systems will be primarily dedicated to tasks other than seismic related tasked. For example, client devices will often be general purpose user computers or smart phones, which are not used primarily for any single purpose, but, rather, used for a wide variety of purposes, business, professional, educational and/or personal.

Because of the wide variety of device types and purposes that daemon hosts may take, the client list and/or associated client locations of a given seismic system may increase and decrease in a somewhat random manner. For example, if a company moves its enterprise servers from the 10^{th} floor to the 20^{th} floor, then that system will now have a somewhat different distribution of client sub-systems (which in this case are thought of primarily as enterprise servers) than it did before the move. Preferably, there are so many client sub-systems, at such a high density, that variations in the exact number and/or locational distribution of client sub-systems will not matter much. Of course, it is always possible for the designers of the system to supplement the system with additional client sub-systems, even if these must take the form of computers solely dedicated to the function of SCD-related information collection for the seismic system.

As the system is continuously refined, it may be helpful for the central server to have some kinds of information about what type of device each client sub-system is. This may help for purposes of information collection and/or analysis. For example, if a given client is a mainframe computer, then almost any movement in this device is likely to be significant for SCD purposes because mainframes are seldom moved either accidentally, or on purpose. As a countervailing example, if the client device is a smart phone, then the device is likely to undergo much movement that is not significant from an SCD perspective. In this case, the central server may not want to collect data from this kind of device nearly as often, perhaps only collecting information when a significant seismic event and its vibrational pattern are known so that movement information from the smart phone, relating to the seismic event, can be culled from its relatively chaotic and constant pattern of user-induced movements. Many variations are possible depending upon how sophisticated the seismic system is and what type(s) of client sub-system hardware (for example, mainframe, desktop, laptop, tablet, smart phone) is allowed to be included in the system.

Returning to FIG. 4, process 400 proceeds to step S402 where db 242 0f server sub-system 102 (see FIG. 2A) is loaded with historical data. It is noted that this historical data may cause some refinement of the identity and/or location of the respective client sub-systems. For example, if historical data is lacking for a given building in a complex, then the system designer may want to purposely try to locate client sub-systems in that particular historical-data-lacking building. It may not always be critical to have the historical data present in the central server before a seismic event occurs (see discussion of step S403 below), but, I this historical data is present, then it can speed SCD results and/or other types of earthquake related analysis. This can be important in embodiments where time is likely to be critical (such as earthquake emergency response).

At step S403, a seismic event occurs. This could be a mainshock, a fore-shock or an aftershock. It may be a seismic event that is so small in amplitude that it would not be considered as any sort of earthquake or “shock.” The seismic even may not be tectonic in its causes. For example, a building may be shaken by a faraway explosion, or by a large ship hitting a pier. The seismic event, however, should cause sufficient motion to be detected by the motion detectors of the various client sub-systems (or at least some of them).

At step S404, it is determined that a seismic event has occurred. More specifically, event determination sub-mod 302 of seismic mod 240 (see FIG. 2A) determines that a seismic event has indeed occurred.

This seismic event provides an opportunity to perform seismic-characteristic determination (SCD) on the buildings. In some embodiments, this SCD will be performed quickly (for example, to identify structures at risk of collapse, landslide or the like), so, at least in these embodiments, the process will proceed rather quickly (for example, in real time) after the determination of the seismic event has been made. The determination of the seismic event may be made in a conventional way and preferably includes the pattern of motion of the Earth's crust. For examples, the determination of the seismic event may include a determination of amplitudes of motion at various frequencies, directional information, etc. Note that the determination of seismic information of step S404 is not SCD because it does not involve determination of characteristics of structures.

The “determination” of the seismic event could happen in many different ways. For example, it could be determined based on monitoring the client sub-systems themselves. Monitoring by client subsystems can be “enriched” by consideration of one or more of the following: (i) which client sub-systems are plugged/unplugged at a given time; (ii) which client sub-systems are at the office or outside; and (iii) so on. This enriched consideration is potentially new and can help remove false positives that would otherwise happen. The basic determination of whether a seismic event has occurred (putting aside seismic characteristic detection) is preferably performed in a collaborative way by the various client sub-systems working in co-operation with the main system such that a given client subsystem is linked to others system in same building, on same floor, in other proximate building(s) and so on. Not only can this linking help prevent false positives from happening with respect to basic detection of earthquakes and their respective magnitudes, but, according to the present invention the analysis goes further to detect or determine the seismic characteristics of building, or other structures, so that appropriate measures can be taken prior to the happening of the next earthquake. This is a potentially great advantage of at least some embodiments of the present invention.

In this example, the motion detecting software of the various client sub-systems would detect similar movements in a near-simultaneous manner, and this would be a strong indication that a seismic event has indeed occurred. As another example, a network of conventional seismographs (not the client sub-systems of the present invention) could communicate to the central sub-system that a seismic event has occurred. In embodiments where a response is not time critical, a human operator at the central sub-system could enter information about the seismic event “by hand” days, or even weeks, after it has already occurred. In this example, data from the various client sub-systems would need to be continuously collected and maintained (at the client sub-systems themselves and/or at the central sub-system), from a time prior to the seismic event of interest until it was need for the SCD of the present invention.

Processing proceeds to step S405 where the central sub-system collects data from the client sub-systems. More specifically, SCD data collection mod 304 of seismic mod 240 (see FIG. 2A) collects movement data from the various client sub-systems (or at least some of the sub-systems in the area affected by the seismic event). Referring now to FIG. 2B, each client sub-system has a movement detector hardware set 284. In some preferred embodiments, the movement detector hardware set of each client sub-system is one or more of the following types of movement detector hardware sets: (i) incidental movement detector hardware set; (ii) disk-drive-related movement detector hardware set; and/or (iii) user-interface-related movement detector hardware set. Each of the three foregoing types is defined above, for purposes of this document, in the dedicated definitions section.

At step S405, the movement detector hardware set sends its detected movement data to seismic daemon 280, which then sends the data out to the central sub-system through communications unit 252 and network 114 (see FIGS. 2B and 1). Referring now to FIG. 3B, seismic daemon 280 receives the unprocessed movement data from the movement detection hardware at data receipt sub-mod 352. This data is processed and/or stored locally by data processing sub-mod 354. Not all embodiments of the present invention will necessarily process or store movement data locally, and not all embodiments will necessarily include sub-mod 354. If the movement data is stored locally at the client sub-system, it may be stored temporarily, for a mid-range term or permanently. The processing may involve processing to determine whether the data is: (i) likely to be related to a seismic event; or, alternatively (ii) likely to be related to normal operations of the client device (for example, raising a smart phone up to one's face to have a phone conversation).

The detected movement data preferably includes both: (i) location data relating to the location of the client device; and (ii) motion data relating to the physical motion that the client device has experienced. The location data may be based on, for example, global positioning system (GPS) data for the client device, and/or other location determination techniques now known or to be developed in the future. As will be appreciated by those of skill in the art, the client sub-systems and the main system should communicate data according to a “common language” For example, an exemplary data transfer may be formatted as follows: building123-floor3-plugged-singlepcinroom-listoftrustedpc.

Many client devices will have various kinds of “sleep” modes, “hibernate” modes and the like (collectively, “low power consumption modes”). For these client devices, it may or may not be possible to collect movement data from the movement detector hardware set at data receipt sub-mod 352. To the extent it is possible, in a given client device, to continue to collect and/or forward movement data when the client device is in a low power consumption mode, the designer of daemon 280 will generally set the polices on this (perhaps with an opportunity for input on the decision(s) from the user(s) of the client device).

If movement data is only to be forwarded to the central sub-system conditionally, then a determination of whether appropriate preconditions are met will be determined by sub-mod 354. For example, in some embodiments, movement data may be collected/sent conditionally upon one or more of the following preconditions: (i) a request for data from the central sub-system; (ii) geographical location of the client device; (iii) elevational location (for example, floor location) of the client device; (iv) lack of other client devices active in the vicinity; and/or (v) other preconditions that the system designer may choose.

At step S405, data forwarding sub-mod 356 of seismic daemon 280 of the client sub-system sends movement data to SCD data collection 304 sub-mod of seismic mod 240 of central sub-system 102 (see FIGS. 1 to 3B). In some embodiments this data transfer, over a communication network and between remote locations, will happen continuously and on an on-going basis. For example, step S405 could happen substantially continuously during steps S402, S403 and S404. In other embodiments, this sending of movement information across the network may be more intermittent. Of course, if the data is only collected intermittently (as mentioned as a possibility above) then the sending would also presumably be intermittent. As a further possibility with respect to sending the movement data over the network from a client sub-system to the central sub-system, network communications could be interrupted (by an earthquake, by non-seismic related causes). In case of such interruption, at least some embodiments may be programmed so that the client device sends its movement data, as appropriate, after the interruption is over.

In some preferred embodiments of the present invention, data are packeted with a metalanguage agreed upfront between clients grouped by any logical arrangement. This way, there is no need to secure them and the size will generally be quite small in term of bandwidth occupancy. Based on the specific configuration chosen by the system designer, there will generally be multiple packets for an event, such that an earthquake that lasts for, say, 60 seconds would have, for example, 6 packets (1 every 10 seconds), and these packets of data that will provide information, such as the following on the evolution of the seismic event in a manner so that as equipment (for example, communication networks, client sub-systems) become damaged or broken, as much meaningful information as feasible will have already been transferred to the main system prior to the breakage problems occasioned by the earthquake.

Processing proceeds to step S406 where the central sub-system performs SCD to calculate various structure-characteristics of structure(s) (man-made structures or geological formations). One possible type of structure-characteristic is a number, or set of numbers that represent the elastic response of the building. Perhaps the most important seismic characteristic that can be determined by the SCD techniques of the present invention is the elastic reaction of a building. Determination of the elastic reaction generally requires the capability to be able to measure the reaction of: (i) multiple floors of the same building moving under influence of the same seismic event; and/or (ii) multiple buildings in the same proximity moving under influence of the same seismic event. This multiplicity of measurement stations is generally required for calculating elastic reaction of a building in order to detect discrepancies or problems in building construction which have an adverse impact on elastic reaction of the building from an earthquake-safety perspective. Moving beyond buildings, similar things can be said about geological structures. With either buildings or geological structures, those of skill in the art will understand that measures can often be taken to shore up and/or retrofit a building or geological structure which has a detected elastic response that indicates a dangerous condition from an earthquake-safety perspective.

Referring now to FIG. 3A, at step S406, sub-sub-mods 320 and 322 of SCD analysis sub-mod 310 of seismic module 240 of central sub-system 102 use (at least some of) the SCD-related data collected by SCD data collection sub-mod 304 in order to determine the desired structure-characteristics. In some preferred embodiments, SCD analysis sub-mod will also base its determinations, at least in part, upon historical data, such as historical data stored in db 242 (see FIG. 2A). Also, at step S406, historical data stored in db 242 may be augmented with data recently received at step S405, so that this current data can be used in the future as historical data.

Processing proceeds to step S407 where the SCD results are output to: (i) a human user (as a display, a displayable data file, a hard copy print-out, an audio presentation and/or, the like); (ii) another computer (for example, by sending the results to other computer(s) over the network); (iii) memory and/or data storage; and/or (iv) any other entity capable of receiving SCD output in any form now known or to be developed in the future. As an example of output displayed at step S407, FIG. 6 shows screenshot 600, including human-readable SCD output window 602. As suggested by the text in window 602, data from different client devices will be used at step S406 to determine structure characteristics for different structures) of interest. A greater number of client sub-systems, having a high device density per unit area and/or a wide area, are likelier to lead to more accurate and/or more comprehensive SCD information. Therefore, it is generally preferable that systems according to the present invention have many, many client sub-systems registered and/or active at any given moment in time.

As shown by the process flow arrow connecting step S407 to step S403, the central sub-system, and its constituent client sub-systems, may continue monitoring for seismic event, and associated responses, even during and after calculation of some given set of SCD structure characteristics. It is also noted that Steps S403 through S407 may, in some embodiments, be performed substantially continuously and substantially in real time.

The flowchart and block diagrams in the foregoing Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Now that the Figures have been discussed, some general comments will be made in the following paragraphs.

Some embodiments of the present invention will focus not on the identification of seismic events, but, rather, on the specific elastic reaction of buildings. Based on the specific seismic data gathered by the system, and based upon correlation of this data with external information, like the floor of the computer (gathered, for example, by network collection) and global positioning system (GPS) data, the system can provide the specific building elastic reaction to a specific seismic event. In some embodiments of the present invention, the system will also be able to correlate and compare data coming from multiple buildings in the same area with the scope to both: (i) evaluate the seismic reaction of each building, and (ii) extrapolate the specific geological data that cause different geological areas to react in different ways to the same seismic event. The granular elastic reaction will provide the capability to have a seismic risk classification at the local area level and/or at the building level. Finally, the granular data will provide the capability to identify dependencies between seismic events so that seismic events can better be classified (or tentatively classified) as: (i) precursor (or foreshock); (ii) main event (or mainshock); or (iii) successor event (or aftershock).

Earthquake analysis and prevention is a living discipline that is subject to the possibility of improvement, especially when it comes to predicting earthquakes and/or predicting where earthquake damage is likely to be severe. A building's reaction to an earthquake depends upon many factors, which makes it generally difficult to use purely analytical methods to determine how a given building will react to an earthquake and to assign a meaningful earthquake risk factor to a given building. Currently conventional “seismic structure-characteristic determination” is generally costly, and also subject to error. As will be explained in detail below, some embodiments of the present invention may provide a system and method for performing accurate and cost-effective seismic structure-characteristic determination.

Some embodiments of the present invention provide a system that can be configured to automatically collect and correlate seismic information in order to provide a reliable and effective earthquake-damage prevention system. People work in a fully integrated environment having multiple sites and locations working on the same project or otherwise doing business together. The information coming from different building or sites of an organization can be aggregated to build a full set of seismic information that can be consumed by a seismic structure-characteristic determination system.

In some embodiments, multiple virtual-connected groups are defined. These groups may be, for example, company-based or region-based. These groups can collaborate in information collection for use as inputs to a seismic structure-characteristic determination system.

Some embodiments of the present invention may be implemented leveraging the hard disk protection system sensor currently installed on certain portable computers (for example, desktops, laptops, smart phone devices, tablets, netbooks, etc.) primarily for protecting internal components (for example, a hard disk drive) from problems caused from portable computer movements.

In some embodiments, a movement-information program is coupled with a movement sensor (such as a vibration sensor that is already present for protecting a hard disk drive in the portable computer). This movement-information program preferably runs as a background process, such as a program in the form of a system daemon. The movement-information program collects and sends at least some information regarding the intensity of experienced movement of the portable computer to a central sub-system, where the information is combined with other information (current and/or historical) in order to perform seismic structure-characteristic determination.

In some embodiments, most, or all, data concerning movement (or lack thereof) will be sent to the central sub-system. In other embodiments, information will only be sent from the portable computer to the central sub-system if the movement pattern detected at the portable computer is not the sort of movement pattern likely to be encountered during normal operations and/or incidental movements of the portable computer. In some embodiments, the central system may request movement information from a given portable computer. For example, such a request may be made in response to a seismic event that the central sub-system detects and/or is informed of.

In preferred embodiments of the present invention, the collection of information includes collection of movement information from many computers, perhaps even hundreds or thousands. This collection will generally be enriched with other meaningful information like the specific user location, which may be needed to correlate the different data received from different locations (for example, different locations inside a building, locations in different buildings, different geographical locations, etc.). For example the daemon can collect the specific floor of a building where the machine is located (for example, using the network information either cable or wifi). In the event of a seismic event (that is, an earthquake or lesser seismic event), this floor information, in conjunction with the movement information, can be used for determination of the elastic reaction of the building, which is one exemplary form of seismic structure-characteristic determination. Additional information may be communicated in the system, like, for example if a “client” laptop machine is connected to the docking station. This docking status information may be useful because it is example of information that can help the system reliably distinguish movement information generated by a seismic event as opposed to seismic information generated primarily by the computer device being moved around, dropped, etc.

Some comments about dropping the device (especially when the device is a smart phone) will now be made. As an additional aspect of the present invention, or, perhaps, a different invention entirely, data related to the dropping (or other impact) of a device (especially a smart phone may still be useful and valuable for purposes other than earthquake analysis and/or seismic analysis purposes. For example, if a smart phone's accelerometer (or other motion sensing hardware) shows a pattern of movement consistent with the dropping of the smart phone accidentally on the ground by the user, then this information may be sent, by the smart phone to the manufacturer of the phone, the entity that does (or could) insure the smart phone hardware, the entity that does (or could) provide the smart phone warranty and/or like entities that would be interested in an event such as the dropping of the phone. To continue with this example, if it is determined that a user frequently drops her phone then she could be offered (or denied) warranty and/or insurance coverage on this basis. As a variation, if the phone is damaged, and, in the course of making a warranty claim, the user denies dropping her smart phone (and thereby damaging it), then the motion data from the smart phone itself would provide a record that the phone experienced a motion pattern indicative of dropping the phone. This might form a basis for denying the warranty claim, or at least investigating it further.

The system can also be instrumented for avoiding false positive. For example a laptop that is just recently undocked from the docking station: (i) is likely to be moved pursuant to the undocking operation so movements at the time of the undocking may be discarded; and (ii) is somewhat likely to be moved around during the interval until it is docked again so that movements in this interval might be discarded (or at least subject to some type of scrutiny to determine whether the movements are seismically induced or otherwise). Similarly if for example a laptop is in use in a train or in a generic vehicle the configuration can take into account a specific threshold to be overcome in order to take the alarm into account.

Having such a system in place will also allow the system to continuously learn and enrich the local seismic catalog with detailed information. This approach, for example, will likely benefit the methods for forecasting seismic responses of buildings and other structures (for example, geological structures).

So, using a collaborative approach, for example, between multiple users spread across a specific area it can be easy to identify the particular phenomena known as quiescence window allowing a more reliable identification of foreshock events that are seismic predecessors of the mainshocks and aftershocks phenomena whose identification can help provide for an effective alarm system.

Moreover, leveraging similar devices' collective information, that collect in the same area regarding the same seismic event, but with slightly different locations which are respectively known, can provide the capability to identify the earthquake epicenter and/or provide useful information about the geological composition of the area.

Some features which may be present in some embodiments of the present invention may include the following:

(i) Multiple systems are equipped with hard disk protection sensors and system daemon for earthquake protection;

(ii) Systems are virtually connected to create a collaborative seismic prevention system;

(iii) Each seismic event captured by a system is provided to the central system with the needed data (intensity, location . . . );

(iv) Central system aggregates the multiple data in order to evaluate if the alarm is a real alarm or a false one; and/or

(v) The system leverages the real time data together with the historical one to build an alarm or to build a seismic analysis in term of geological characteristic or elastic reaction of the building.

The following paragraphs provide definitions for certain term(s) used in this document:

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

And/or: non-exclusive or; for example, A and/or B means that: (i) A is true and B is false; or (ii) A is false and B is true; or (iii) A and B are both true.

User: includes, but is not necessarily limited to, the following: (i) a single individual human; (ii) an artificial intelligence entity with sufficient intelligence to act as a user; and/or (iii) a group of related users.

Incidental movement detector hardware set: a client device whose primary purpose, or purposes, is not collection of seismic or earthquake related information; incidental movement detector hardware sets include, but are not limited to the following: general purpose computers for business, personal use, educational use and/or entertainment use, smart phones, tablets, etc.

Disk drive movement detector hardware set: any incidental movement detector hardware set which has a movement detector hardware set that is installed in the client device primarily for use with a disk drive.

User interface (UI) movement detector hardware set: any incidental movement detector hardware set which has a movement detector hardware set that is installed in the client device primarily for use as a user input device.

What is claimed is:

1. A method for determining at least one characteristic of at least one structure, the method comprising:
providing a server sub-system comprising a processor set and seismic software that runs on the processor set, with the sever sub-system being in data communication with a communication network;
receiving, by the server sub-system and through the communication network, first detected movement information, relating to seismically-induced movement of a first client device; and
performing structure-characteristic determination, by the seismic software of the server sub-system, to determine at least one structure characteristic of a first structure based, at least in part, upon the first detected movement information.

2. The method of claim 1 wherein the first client device is an incidental movement detector hardware set.

3. The method of claim 2 wherein the first client device is a disk drive movement detector hardware set.

4. The method of claim 1 wherein:
the receiving step is performed a plurality of times for a plurality of client devices; and
the determination of the at least one structural characteristic of the performing step is based, at least in part, upon a detected movement information from a plurality of the plurality of client devices.

5. The method of claim 1 wherein the first detected movement information includes: (i) position information relating to a location of the first client device; and (ii) motion information relating to relatively small scale physical motion of the first client device.

6. The method of claim 1 wherein the structure characteristic determined at the performing step is an elastic response characteristic of a structure.

7. A server sub-system, for use with a plurality of client sub-systems including a first client sub-system, for determining at least one characteristic of at least one structure, the sub-system comprising:
a processor set; and
seismic software
wherein:
the seismic software runs on the processor set;
the sever sub-system is in data communication with a communication network; and
the seismic software is programmed to: (i) receive, through the communication network, first detected movement information relating to seismically-induced movement of the first client device, and (ii) perform structure-characteristic determination to determine at least one structure characteristic of a first structure based, at least in part, upon the first detected movement information.

8. The sub-system of claim 7 wherein the first client device is an incidental movement detector hardware set.

9. The sub-system of claim 8 wherein the first client device is a disk drive movement detector hardware set.

10. The sub-system of claim 7 wherein the seismic software is further programmed to: (i) receive, through the communication network, detected movement information, respectively relating to seismically-induced movement of a plurality of the plurality of client devices, and (ii) perform structure-characteristic determination to determine at least one structure characteristic of a first structure based, at least in part, upon detected movement information from the plurality of the plurality of client devices.

11. The sub-system of claim 7 wherein the first detected movement information includes: (i) position information relating to a location of the first client device; and (ii) motion information relating to relatively small scale physical motion of the first client device.

12. The sub-system of claim 7 wherein the structure characteristic determined by the seismic software is an elastic response characteristic of a structure.

13. A seismic software, for running on a server sub-system used with a plurality of client sub-systems including a first client sub-system, which client sub-systems are in data communication with the server sub-system through a communication network, the software for determining at least one characteristic of at least one structure, the software comprising:
a data collection module programmed to receive, through the communication network, first detected movement information relating to seismically-induced movement of the first client device; and
an analysis module programmed to perform structure-characteristic determination to determine at least one structure characteristic of a first structure based, at least in part, upon the first detected movement information;
wherein:
the seismic software is stored in and/or on a storage device in a manner less transitory than a signal in transit.

14. The software of claim 13 wherein the first client device is an incidental movement detector hardware set.

15. The software of claim 14 wherein the first client device is a disk drive movement detector hardware set.

16. The software of claim 13 wherein:
the data collection module is further programmed to receive, through the communication network, detected movement information, respectively relating to seismically-induced movement of a plurality of the plurality of client devices; and
the analysis module is further programmed to perform structure-characteristic determination to determine at least one structure characteristic of a first structure based, at least in part, upon detected movement information from the plurality of the plurality of client devices.

17. The software of claim 13 wherein the first detected movement information includes: (i) position information relating to a location of the first client device; and (ii) motion information relating to relatively small scale physical motion of the first client device.

18. The software of claim 13 wherein the structure characteristic determined by the analysis module is an elastic response characteristic of a structure.
